(19) United States
(12) Patent Application Publication
(10) Pub. No.: US 2025/0150782 A1
(43) Pub. Date: May 8, 2025

(54) VEHICLE MESSAGE FILTERING

(71) Applicant: Ford Global Technologies, LLC, Dearborn, MI (US)

(72) Inventors: Niraj Altekar, Mumbai (IN); Jayanthi Rao, West Bloomfield, MI (US); Syed Amaar Ahmad, Canton, MI (US)

(21) Appl. No.: 18/502,288

(22) Filed: Nov. 6, 2023

(51) Int. Cl. H04W 4/02; H04W 4/44

(52) U.S. Cl. CPC H04W 4/023; H04W 4/027; H04W 4/44

(57) ABSTRACT

Filtering of V2X messages is performed by an ego vehicle. A velocity of travel of the ego vehicle is identified. One or more distance thresholds of dynamic filter criteria are adjusted according to the identified velocity. Via a transceiver of the ego vehicle, a vehicle-to-everything (V2X) message is received. From the V2X message, a location of a remote road entity of the V2X message is identified. The V2X message is filtered based on whether the location of the remote road entity is within the one or more distance thresholds. The V2X message is only processed if the V2X message is not filtered out, thereby reducing resource usage due to the filtered out V2X messages.

### TECHNICAL FIELD

Aspects of the disclosure generally relate to filtering of vehicle-to-everything (V2X) messages using dynamic filter criteria and/or signal strength.

### BACKGROUND

V2X allows vehicles to exchange information with other vehicles, as well as with infrastructure, pedestrians, networks, and other devices. Vehicle-to-infrastructure (V2I) communication enables applications to facilitate and speed up communication or transactions between vehicles and infrastructure. In a vehicle telematics system, a telematics control unit (TCU) may be used for various remote-control services, such as over the air (OTA) software download, eCall, and turn-by-turn navigation.

### SUMMARY

In one or more illustrative examples, an ego road entity for performing filtering of V2X messages includes a transceiver and one or more controllers. The one or more controllers are configured to identify velocity of travel of the ego road entity, adjust one or more distance thresholds of dynamic filter criteria according to the identified velocity, receive, via the transceiver, a V2X message, identify, from the V2X message, a location of a remote road entity indicated by the V2X message, filter the V2X message based on whether the location of the remote road entity is within the one or more distance thresholds, and process the V2X message only if the V2X message is not filtered out.

In one or more illustrative examples, a method for filtering of V2X messages is performed by an ego road entity. A velocity of travel of the ego road entity is identified. One or more distance thresholds of dynamic filter criteria are adjusted according to the identified velocity. Via a transceiver of the ego road entity, a V2X message is received. From the V2X message, a location of a remote road entity of the V2X message is identified. The V2X message is filtered based on whether the location of the remote road entity is within the one or more distance thresholds. The V2X message is only processed if the V2X message is not filtered out.

In one or more illustrative examples, a non-transitory computer readable medium includes instructions for filtering of V2X messages by an ego vehicle that, when executed by one or more controllers, cause the one or more controllers to perform operations including to identify velocity of travel of the ego vehicle; adjust one or more distance thresholds of dynamic filter criteria according to the identified velocity; receive, via a transceiver of the ego vehicle, a V2X message y; identify, from the V2X message, a location of a remote road entity indicated by the V2X message; derive a statistical measure of received signal strength indicator (RSSI) of other V2X messages from the remote road entity over a period of time; filter out the V2X message responsive to the statistical measure not meeting a threshold value over the period of time, wherein the statistical measure is mean, median, or maximum RSSI over the period of time filter the V2X message based on whether the location of the remote road entity is within the one or more distance thresholds, and process the V2X message only if the V2X message is not filtered out.

### BRIEF DESCRIPTION OF THE DRAWINGS

FIG. 1 illustrates an example system for performing filtering of V2X messages using dynamic filter criteria and/or signal strength;

FIG. 2 illustrates an example of filtering V2X messages from road entities based on location and direction of travel;

FIG. 3 illustrates an example of filtering V2X messages from road entities based on distance;

FIG. 4 illustrates an example of filtering V2X messages from roadside units (RSUs) managing intersections;

FIG. 5 illustrates an example of filtering V2X messages based on signal strength;

FIG. 6 illustrates an example process for performing filtering of V2X messages using dynamic filter criteria;

FIG. 7 illustrates an example process for performing filtering of V2X messages using signal strength; and

FIG. 8 illustrates an example of a computing device for use in performing filtering of V2X messages using dynamic filter criteria and/or signal strength.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Connected vehicles may broadcast their location, speed, heading, and other information using V2X communication. This information may be broadcast to allow other traffic participants to be aware of the vehicle's presence. For example, the information may be used by other traffic participants to make decisions while traveling along the roadway.

However, the connected vehicles may coexist with older vehicles that may not have communication capabilities. Also, some road users, such as pedestrians and bicyclists, may not have V2X capabilities. As a result, such road users cannot share their information with other road users.

Some vehicles come equipped with sensor systems that can recognize objects in the surrounding environment. Connected and sensor equipped smart infrastructure can also perceive the surrounding information and share it with connected road users. Through cooperative sensor data sharing systems, connected and sensor system equipped vehicles and infrastructure can share their perceived information with the other connected road users.

As a result, at any given time, there could be multiple sensor-equipped vehicles and infrastructure entities (e.g., roadside units at intersections) sharing their sensor data through sensor sharing messages. This may result in duplicate and excessive information being broadcast. Processing the duplicate and excessive sensor information may overload the applications processor on the receiver end and result in inefficient use of available communication and compute resources.

This may be especially problematic in a vicinity that has multiple animals, pedestrians or non-equipped vehicles, such that each unique object is simultaneously detected by multiple vehicles and infrastructure elements which broadcast their respective information. Often vehicles may naively duplicate information about a commonly-detected objected and share with each other when it is already known to itself.

Aspects of the disclosure present conditions to filter excessive and duplicate sensor information being passed to the downstream applications hosted by an ego vehicle. As used herein, the term ego vehicle or ego road entity refers to the vehicle or road entity that is the receiver of the V2X messages. This ego road entity may in some examples be a vehicle, RSU, but may be any other road entity having communications and processing capabilities for participation in V2X communication. The ego road entity may discard a received V2X message if the received V2X message meets one or more of the conditions defined herein. The conditions may be defined based on the ego road entity's instantaneous location, its direction of travel, and the presence of nearby connected intersections broadcasting V2X messages in the vicinity of the ego road entity.

For ease of explanation herein, it may be assumed that the V2X message is unencrypted, and that the receiving road entity can use the V2X message fields to calculate the distances first in preliminary stage before passing the packet to application layer for extensive processing. It may also be assumed for many examples that application-layer processing of an V2X message is more computation-intensive than lower link-layer processing. Thus, the resource utilization savings for not performing application-layer processing for filtered out messages may be useful and significant to the ego road entity.

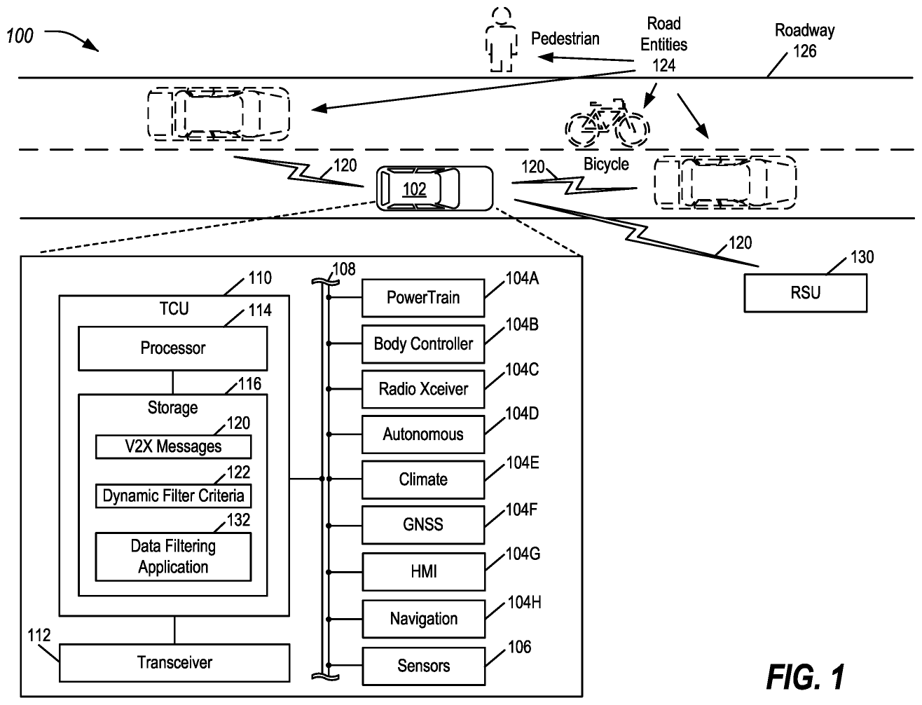

FIG. 1 illustrates an example system 100 for performing filtering of V2X messages 120 using dynamic filter criteria and/or signal strength. The system 100 may include a vehicle 102 having controllers 104 that communicate over one or more vehicle buses 108. The vehicles 102 may also include a TCU 110 configured to provide communications services via a transceiver 112. The TCU 110 may include a processor 114 and storage 116. The TCU 110 may be used to send and receive V2X messages 120. The V2X messages 120 may relate to road entities 124 in the roadway 126, RSUs 130, or other objects in the environment surrounding the vehicle 102 (e.g., road signs, smart and connected infrastructure, etc.). A data filtering application 132 may be installed to the TCU 110 and may be configured to associate and filter information in the V2X messages 120. It should be noted that the system 100 is only an example, and systems 100 having more, fewer, and different components may be used.

The vehicle 102 may include various types of automobile, crossover utility vehicle (CUV), sport utility vehicle (SUV), truck, recreational vehicle, motorcycle, boat, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle powered by one or more electric motors. As a further possibility, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle.

The vehicle 102 may be a vehicle driven by a driver with driver assistance features. In other examples, the vehicle may be a semi-autonomous vehicle (AV). These AV or driver assistance features may be supported via received V2X data and/or optical data. The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians, which may be equipped with V2X technology.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as the exterior lights 118, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature, etc.); a global navigation satellite system (GNSS) controller 104F may be configured to provide vehicle location information; a human-machine interface (HMI) controller 104G may be configured to receive user input via various buttons or other controls, as well as provide vehicle status information to a driver, such as fuel level information, engine operating temperature information, and current location of the vehicle 102; and a navigation controller 104H configured to provide routing services to the user such as turn-by-turn directions.

The controllers 104 of the vehicle 102 may make use of various sensors 106 in order to receive information with respect to the surroundings of the vehicle 102. In an example, these sensors 106 may include one or more of visible light sensors 106 (e.g., advanced driver assistance system (ADAS) sensors 106), infrared sensors 106, and/or multi-spectrum sensors 106. In some examples, the sensors 106 may include capture devices that operate using other approaches such as radar systems and/or lidar systems. In some examples, the sensors 106 may include rolling shutter complementary metal oxide semiconductor (CMOS) sensors 106 configured to receive light-based transmissions.

The vehicle bus 108 may include various methods of communication available between the vehicle controllers 104, as well as between the TCU 110 and the vehicle controllers 104. As some non-limiting examples, the vehicle bus 108 may include one or more of a controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access the transceiver 112 configured to facilitate communication with other vehicles 102 or with infrastructure. The TCU 110 may be configured to communicate over a broadcast peer-to-peer protocol (such as PC5), to facilitate cellular V2X (C-V2X) communications with devices such as other vehicles 102. The TCU 110 may also be configured to communicate over cellular networks to communicate over the Internet with other devices. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 114 configured to execute computer instructions, and a storage 116 medium on which the computer-executable instructions and/or data may be maintained. A computer-readable storage medium (also referred to as a processor-readable medium or storage 116) includes any non-transitory (e.g., tangible) medium that participates in providing data (e.g., instructions) that may be read by a computer (e.g., by the processor(s)). In general, the processor 114 receives instructions and/or data, e.g., from the storage 116, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, JAVA, C, C++, C #, FORTRAN, PASCAL, VISUAL BASIC, PYTHON, JAVASCRIPT, PERL, etc.

The TCU 110 may be configured to facilitate the collection of V2X messages 120 and/or other vehicle information from the vehicle controllers 104 connected to the one or more vehicle buses 108.

The V2X messages 120 may include collected information retrieved from the controllers 104 over the vehicle buses 108. In many examples, the collected information data may include information useful for autonomous vehicle operations or driver-assistance vehicle operations. The connected vehicle data information retrieved by the TCU 110 may include, as some non-limiting examples, an identifier (ID) of the sender, as well as data about the sender such as latitude, longitude, time, heading angle, speed, lateral changes in speed, longitudinal changes in speed, yaw rate, throttle position, brake status, steering angle, headlight status, wiper status, external temperature, turn signal status, vehicle length, vehicle width, vehicle mass, and bumper height. The connected vehicle data information may also include, weather data (such as ambient temperature, ambient air pressure, etc.), traction control status, wiper status, or other vehicle status information (such as the status of exterior vehicle lights, type of vehicle, antilock brake system (ABS) system status, etc.).

The V2X messages 120 may also include information with respect to detected road entities 124. For instance, the V2X message 120 may indicate information such as location, size, and/or contour of detected road entities 124 along a roadway 126. The V2X message 120 may also indicate a type of the road entity 124 (e.g., pedestrian, car, truck, debris, etc.). It should be noted that, as a matter of perspective, a vehicle 102 may be an ego road entity 124 to other vehicles 102. Therefore, aspects that are discussed in terms of a vehicle 102 may be performed by a road entity 124 from its perspective, and vice versa. Moreover, operations that are discussed as being performed by a vehicle 102 as an ego road entity 124 may also be performed by other types of road entity 124, such as by an RSU 130. The road entity 124 may, in turn, be equipped with V2X capabilities.

In some examples the road entities 124 may involve communication via one or more RSUs 130. The RSU 130 may be a device with processing capabilities and networking capabilities and may be designed to be placed in proximity of a roadway 126 for use in communicating with the vehicles 102. For instance, the RSU 130 may include hardware configured to communicate over the broadcast peer-to-peer protocol (such as PC5), to facilitate C-V2X communications with the vehicles 102. In another example, a machine learning model may be hosted by the RSU 130 to allow the road entities 124 to be classified without using compute power of the vehicles 102. The RSU 130 may, accordingly, be able to communicate with multiple vehicles 102 along a specific roadway 126 or in a specific area. The RSU 130 may also have wired or wireless backhaul capability to allow for communication with other elements of a traffic control system, via e.g., Ethernet, or cellular connection to the cellular network infrastructure, for example over Uu interface.

While a single vehicle bus 108 is illustrated, it should be noted that in many examples, multiple vehicle buses 108 are included, with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

The TCU 110 may be further configured to periodically transmit V2X messages 120 for reception by remote vehicles. The position, dimension and heading of the ego vehicle 102 may be broadcast by the ego vehicle 102 in the V2X messages 120. In an example, the frequency of sending the V2X messages 120 may be on the order of every ten milliseconds. A V2X radio may be a relatively short-range communications unit (e.g., with a range on the order of one kilometer). In an example, the V2X radio may operate on Cellular V2X (e.g., C-V2X 3GPP). In another example, the V2X radio may operate on Institute of Electrical and Electronics Engineer (IEEE) 802.11p Dedicated Short Range Communication (DSRC). In one example, the V2X messages 120 may take the form of BSM messages as described in the Society of Automotive Engineers (SAE) standard document J2735. In another example, the V2X message 120 may take the form of SDSM messages as described in the SAE standard document J3224.

The TCU 110 may be further configured to receive V2X messages 120 from other vehicles 102 or other road entities 124. In an example, the vehicle 102 may be referred to as a host vehicle (HV) and remote vehicles (RV) surrounding the HV may be in communication with the vehicle 102 as road entities 124. In another example, the HV may be in communication with other road entities 124, such as bicyclists, pedestrians, etc.

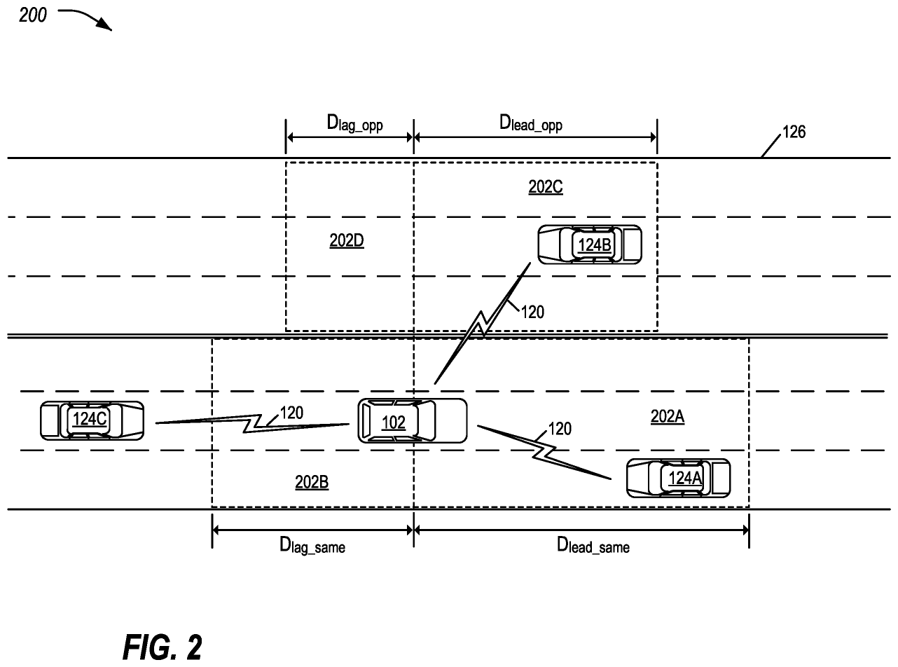

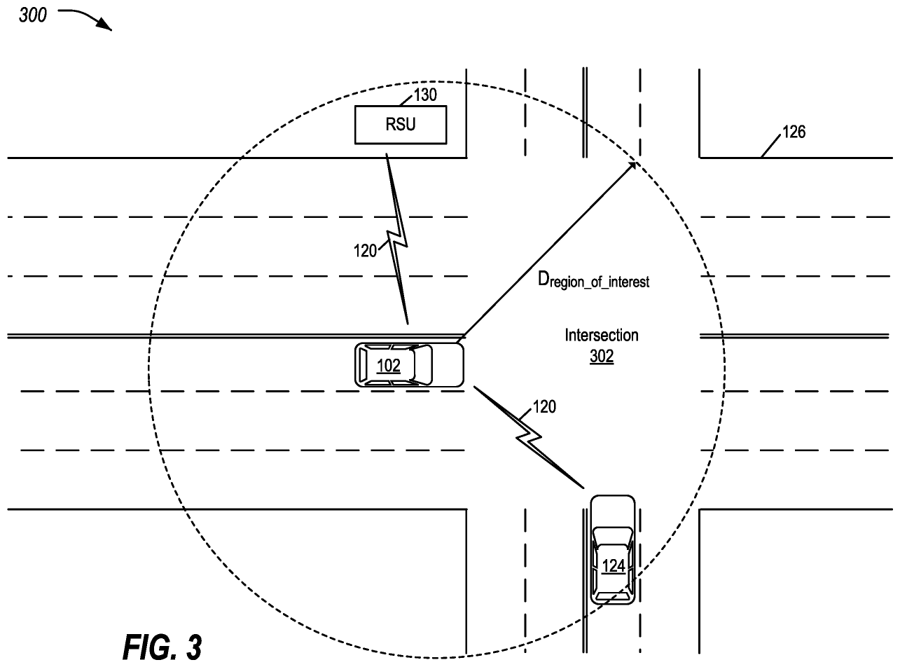

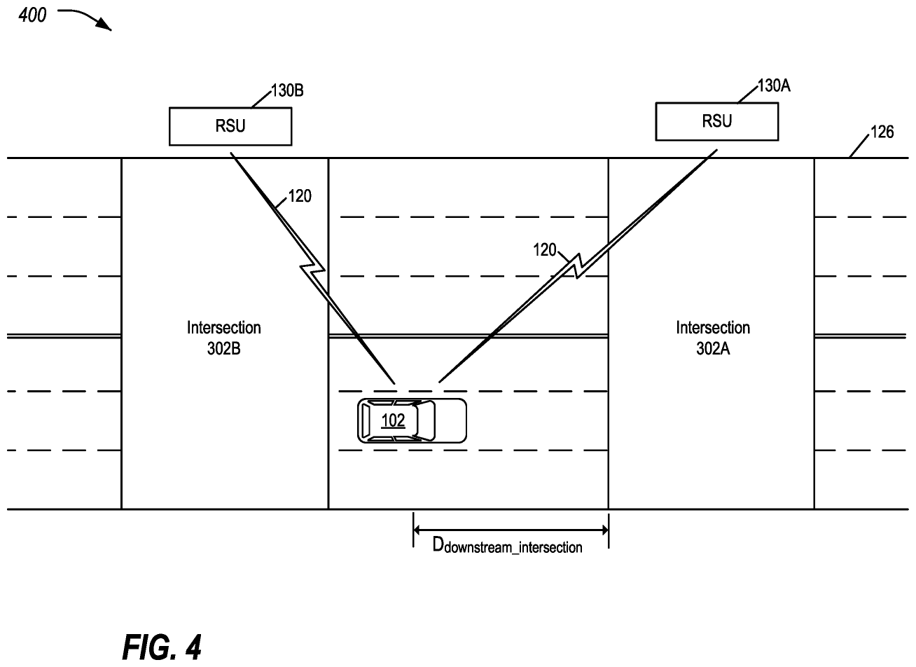

The management of sending, receiving, and filtering of V2X messages 120 may be handled by a data filtering application 132 executed by the TCU 110. The data filtering application 132 may be configured to filter excessive and duplicate sensor 106 information being passed to the downstream applications hosted by the ego vehicle 102. The data filtering application 132 may discard a received V2X message 120 if the received V2X message 120 meets one or more of the conditions defined herein. The conditions may be defined based on the direction of travel of the ego vehicle 102 (as shown in FIG. 2), the instantaneous location of the ego vehicle 102 (as shown in FIG. 3), and/or the presence of RSUs 130 of connected intersections broadcasting V2X messages 120 in the vicinity of the ego vehicle 102 (as shown in FIG. 4).

Dynamic filter criteria 122 may be used to define which conditions and settings are applicable to the filtering of the V2X messages 120 by the data filtering application 132. The dynamic filter criteria 122 may specify which conditions apply to the filtering of V2X messages 120 as well as what thresholds apply to the conditions for the filtering of the V2X messages 120. Examples of the conditions and the dynamic filter criteria 122 are discussed in detail herein.

FIG. 2 illustrates an example 200 of filtering V2X messages 120 from road entities 124 based on location and direction of travel. An ego vehicle 102 is shown along a roadway 126. Four regions 202 are shown, based on the location of the ego vehicle 102. These regions 202 include a first region 202A in front of the ego vehicle 102 in the direction of travel of the ego vehicle 102 (as defined by distance d_{leadsame}), a second region 202B behind the ego vehicle 102 in the direction of travel of the ego vehicle 102 (as defined by distance d_{lagsame}), a third region 202C in front of the ego vehicle 102 in an opposite direction from the direction of travel of the ego vehicle 102 (as defined by distance d_{leadopp}), and a fourth region 202D behind the ego vehicle 102 in the opposite direction from the direction of travel of the ego vehicle 102 (as defined by distance d_{lagopp}).

In some examples, d_{leadsame} may be set to be larger than d_{lagsame} or d_{leadopp}, as road entities 124 in the same travel direction as the ego vehicle 102 may be considered to be more relevant than road entities 124 in the opposite travel direction from the ego vehicle 102. In another example, d_{lagopp} may be set to be less than d_{lagsame}, as road entities 124 behind the ego vehicle 102 and increasing in distance away from the ego vehicle 102 may be considered to be less relevant than road entities 124 in the same travel direction of the ego vehicle 102. As shown, the first region 202A and the second region 202B are of greater distance along the roadway 126 in front of and being the ego vehicle 102 as compared to the third region 202C and fourth region 202D. It should be noted that this is an example, and differently sized and arranged regions 202 may be used.

In other examples, d_{leadopp} may be set to same as or even greater than d_{leadsame}, such as for undivided highways, as opposing road entities 124 may be of relatively more interest to the ego vehicle 102 due to the relative different in velocity. In still other examples, the thresholds d may differ for different types of road entity 124. For example, slower moving types of road entities 124 such as bicycles or stationary obstacles may have shorter thresholds d than other types of road entities 124 such as remote vehicles. In an example, slow or stationary road entities 124 may have zero or very short d_{lagsame} or d_{lagopp}, as such road entities 124 are unlikely to affect forward travel of the ego vehicle 102.

The distance parameters d may be configurable aspects of the dynamic filter criteria 122. In an example, the dynamic filter criteria 122 may specify for the distance parameters d to be continuously calculated in real-time as a function of instantaneous speed or velocity of the ego vehicle 102. The road topology may also be considered while computing the distances d. For instance, the distances d may therefore refer to the distance along the road curvature, not a simple straight-line distance from the ego vehicle 102.

Continuing with the example 200, the ego vehicle 102 may discard V2X messages 120 that are one or more of: broadcast by a road entity 124 travelling in the same direction as that of the ego vehicle 102 where the road entity 124 is behind the ego vehicle 102 by distance d_{lagsame}, broadcast by a road entity 124 travelling in the same direction as that of the ego vehicle 102 where the road entity 124 is ahead of the ego vehicle 102 by distance d_{leadsame}, broadcast by a road entity 124 travelling in the opposite direction as that of the ego vehicle 102 where the road entity 124 is behind the ego vehicle 102 by distance d_{lagopp}, or broadcast by a road entity 124 travelling in the opposite direction as that of the ego vehicle 102 where the road entity 124 is ahead of the ego vehicle 102 by distance d_{leadopp}. For instance, the data filtering application 132 may allow the V2X messages 120 from road entity 124A (within first region 202A) and 124B (within third region 202C), but may discard the V2X messages 120 from the road entity 124C (outside all of the regions 202A-D).

FIG. 3 illustrates an example 300 of filtering V2X messages 120 from road entities 124 based on distance. An ego vehicle 102 is shown along a roadway 126. V2X messages 120 may be broadcast by the RSU 130 managing an intersection 302. These V2X messages 120 may be received to the ego vehicle 102.

A region 202 of interest is defined by a radius of distance d_{region_of_interest} surrounding the ego vehicle 102. In this example 300, V2X messages 120 that are broadcast by a road entity 124 outside the region 202 may be discarded. The radius of the region 202 may be configurable parameter of the dynamic filter criteria 122 or may be derived from the instantaneous speed or velocity of the ego vehicle 102 pursuant to the dynamic filter criteria 122. This alternate example 300 may be used when the ego vehicle 102 is in the vicinity of a RSU 130 of an intersection 302 (especially ones broadcasting V2X messages 120) to continue to process the V2X messages 120 broadcast by road entities 124 traveling perpendicular to the ego vehicle 102.

FIG. 4 illustrates an example 400 of filtering V2X messages 120 from RSUs 130 managing intersections 302. As shown, an intersection 302A is downstream from the ego vehicle 102, while an intersection 302B is upstream from the ego vehicle 102. Information with respect to the intersection 302A may be broadcast by a first RSU 130A in proximity to the intersection 302A. Information with respect to the intersection 302B may be broadcast by a second RSU 130B in proximity to the intersection 302B. V2X messages 120 may be broadcast by the first RSU 130A and second RSU 130B. These V2X messages 120 may be received to the ego vehicle 102.

The data filtering application 132 may discard the V2X message 120 if the V2X message 120 is broadcast by an upstream intersection 402 from which the ego vehicle 102 has already departed. In the example 400, this may include the intersection 302B. In another example, the data filtering application 132 may discard the V2X message 120 if the V2X message 120 is broadcast by an upstream intersection 402 that is farther than a distance of d_{downstream_intersection} from the ego vehicle 102.

These conditions may be especially applicable when the ego vehicle 102 is traveling in arterial corridors comprised of smart intersections 302 that are configured to broadcast V2X messages 120 such as SDSMs. In another aspect, if the route of the ego vehicle 102 is known to the data filtering application 132, the data filtering application 132 may discard the V2X messages 120 if the V2X messages 120 are broadcast by an intersection 302 that is not along the current route of the ego vehicle 102. In yet another example, similar to conditions shown in FIG. 3, a region 202 may be defined using fixed or a velocity-derived radius. In such a case, the V2X message 120 may be discarded by the data filtering application 132 if the V2X messages 120 are broadcast by an intersection 302 outside the region 202.

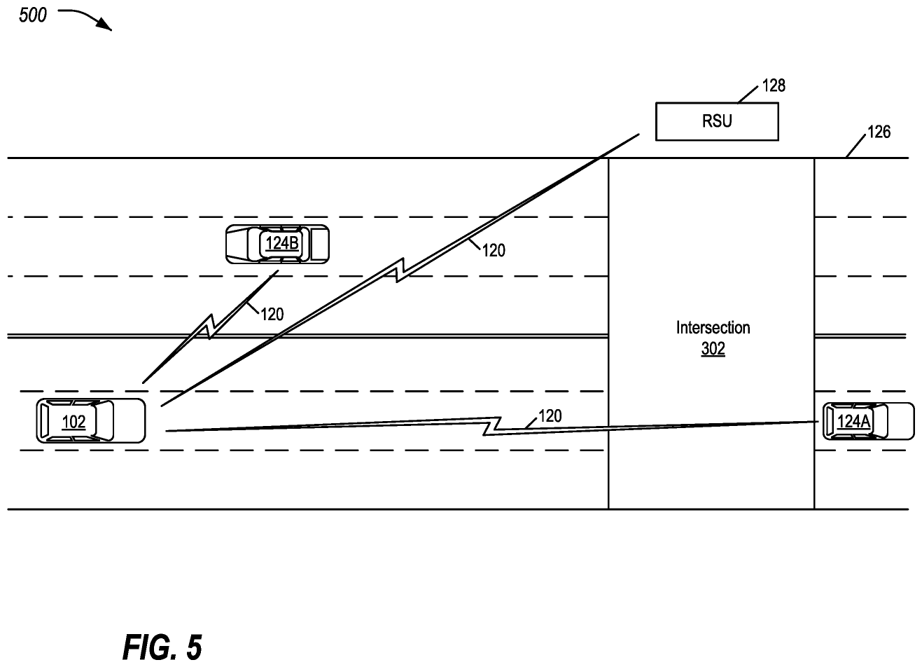

FIG. 5 illustrates an example 500 of filtering V2X messages 120 based on signal strength. In an example, the ego vehicle 102 may use received signal strength indicator (RSSI) of the V2X messages 120 to drop V2X messages 120 that are received at an RSSI below a predefined threshold strength, as these V2X messages 120 likely correlated to being further away.

The ego vehicle 102 may utilize the transceiver 112 to scan and accept multiple V2X messages 120 from a single source within a short interval (such as a second or less) for application processing. However, after this interval elapses, the data filtering application 132 may derive a statistical measure of the RSSI of the received V2X messages 120. This statistical measure may include mean, median, or maximum RSSI, as some non-limiting examples. Responsive to the statistical measure not meeting a minimum threshold, then no further V2X messages 120 may be processed from that source (e.g., that road entity 124 or RSU 130) unless the RSSI measure crosses the threshold.

Additional criteria may be used for filtering V2X messages 120 as well. In an example, V2X message 120 may include information regarding one or more objects detected by sensors 106 of a road entity 124 or RSU 130. Filtering criteria may additionally be applied by the data filtering application 132 to the individual objects contained within with V2X message 120. For example, sensed objects outside the regions 202 may be discarded to reduce processing overhead.

In yet another example, filtering of V2X messages 120 may also be combined with the packet byte size or equivalent C-V2X Resource Blocks, where large V2X message 120 packets presumably contain information about multiple objects (e.g., more than one) and thus are more valuable to process than those with a single object (e.g., smaller V2X message 120 packets or fewer radio-level C-V2X Resource Blocks).

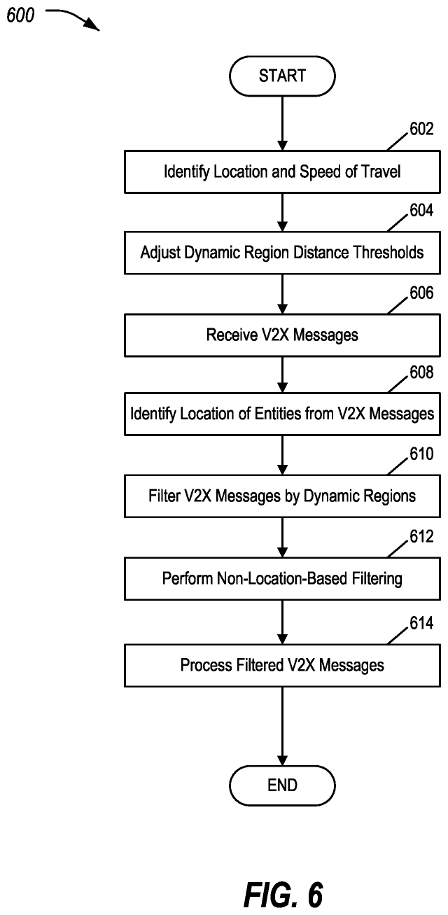

FIG. 6 illustrates an example process 600 for performing filtering of V2X messages 120 using dynamic filter criteria 122. In an example, the process 600 may be performed by the data filtering application 132 executed by the TCU 110 of the ego vehicle 102.

At operation 602, the ego vehicle 102 identifies a location and a velocity of travel of the ego vehicle 102. In an example, the TCU 110 may determine the velocity of the ego vehicle 102 based on information from the controllers 104 captured over the one or more vehicle buses 108. For example, information such as road speed or engine speed may be made available to the TCU 110 by the powertrain controller 104A. In another example, the vehicle location may be captured by the TCU 110 from the GNSS controller 104F, and/or the velocity from changes in location determined by the GNSS controller 104F. In yet another example, the velocity and/or location information may be received from the navigation controller 104H of the ego vehicle 102.

At operation 604, the ego vehicle 102 adjusts distance thresholds of the dynamic filter criteria 122 of the ego vehicle 102. In an example, the region 202 of interest may be defined by a radius of distance d_{region_of_interest} surrounding the location of the ego vehicle 102. This distance d_{region_of_interest} may be increased as the velocity of the ego vehicle 102 increases.

In another example, a set of regions 202 may be defined with respect to the location of the ego vehicle 102. This set of regions 202 may include a first region 202A in front of the ego vehicle 102 in the direction of travel of the ego vehicle 102 (as defined by distance d_{leadsame}), a second region 202B behind the ego vehicle 102 in the direction of travel of the ego vehicle 102 (as defined by distance d_{lagsame}), a third region 202C in front of the ego vehicle 102 in an opposite direction from the direction of travel of the ego vehicle 102 (as defined by distance d_{leadopp}), and a fourth region 202D behind the ego vehicle 102 in the opposite direction from the direction of travel of the ego vehicle 102 (as defined by distance d_{lagopp}).

Each of these distances d may be adjusted based on the velocity of the ego vehicle 102. In an example, the ego vehicle 102 may adjust the one or more distance thresholds d by increasing each of the d_{leadsame}, d_{lagsame}, d_{leadopp}, and d_{lagopp} thresholds as the velocity of the ego vehicle 102 increases, as the possibility for interaction with road entities 124 may increase with velocity. In another example, the ego vehicle 102 may adjust the one or more distance thresholds by increasing each of d_{leadsame} and d_{leadopp}, as road entities 124 in the travel direction of the ego vehicle 102 may be considered more relevant at higher velocities. In yet another example, the ego vehicle 102 may adjust the one or more distance thresholds by increasing each of d_{leadsame} and d_{leadopp}, but reducing each of d_{lagsame} and d_{lagopp}, as the road entities 124 behind the ego vehicle 102 may be of less concern at higher velocities.

With respect to the amount of change in the distances d, in an example, the amount of increase in the one or more distance thresholds may be proportional to distance traveled by the ego vehicle 102 per unit time. For instance, at thirty miles per hour the ego vehicle 102 may travel approximately forty-four feet per second, while at sixty miles per hour the ego vehicle 102 may travel approximately eighty-eight feet per second. Thus, the distances d may be doubled at sixty miles per hour vs thirty miles per hour, to provide for the same amount of time in processing V2X messages 120 from upcoming road entities 124.

At operation 606, the ego vehicle 102 receives V2X messages 120. In an example, the TCU 110 may receive V2X messages 120 from road entities 124 such as remote vehicles or bicycles. In another example, the TCU 110 may receive V2X messages 120 from RSUs 130 that may be managing intersections 302 along the roadway 126. The V2X messages 120 may take various forms. In one example, the V2X messages 120 may take the form of BSM messages as described in the SAE standard document J2735. In another example, the V2X message 120 may take the form of SDSM messages as described in the SAE standard document J3224.

At operation 608, the ego vehicle 102 identifies locations of road entities 124 based on the V2X messages 120. In an example, the V2X messages 120 may specify the location of the sender in the V2X messages 120. These may be used as the locations of such road entities 124. In another example, the V2X message 120 may specify the location of road entities 124 other than the sender of the V2X message 120. For instance the RSU 130 may indicate the locations of pedestrians, potholes, or other road entities 124. In such an example, the locations of the road entities 124 may be considered, as opposed to the location of the sender which may be less relevant.

At operation 610, the ego vehicle 102 filters the V2X messages 120 by the locations. For example, if the locations of the sender specified by a V2X message 120 as determined in operation 608 is within the one or more regions 202 as adjusted at operation 604, then the V2X message 120 may be passed through. Otherwise, the V2X message 120 may be filtered out.

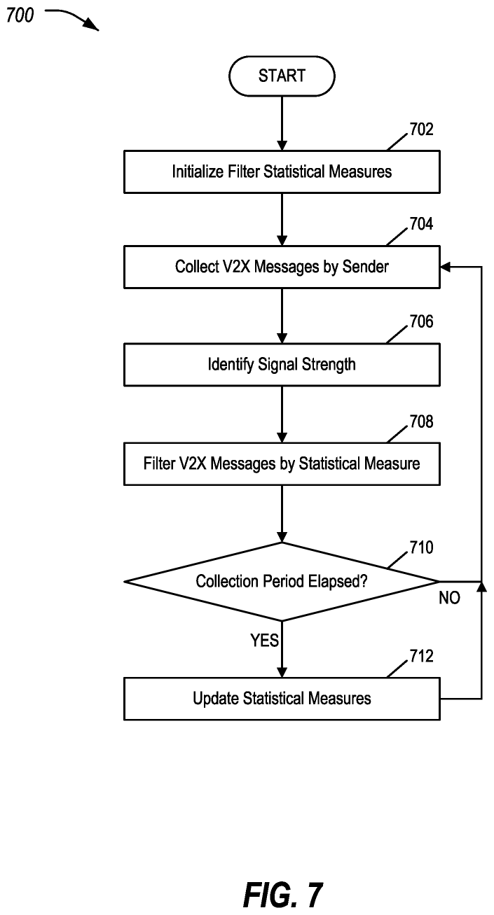

At operation 612, the ego vehicle 102 optionally performs non-location-based filtering of the V2X messages 120. In an example the non-location based filtering may include filtering based on signal strength. Further aspects of such an approach are discussed with respect to FIG. 7 below.

At operation 614, the ego vehicle 102 processes the V2X messages 120 as filtered. This may include, for example, passing the V2X messages 120 to the autonomous controller 104D to aid in the driving of the ego vehicle 102. In another example, this may include passing the V2X messages 120 to the navigation controller 104H and/or HMI controller 104G for display to vehicle occupants. In yet another example, this may include rebroadcasting information about road entities 124 to other traffic participants, e.g., using the transceiver 112. After operation 614, the process 600 ends.

FIG. 7 illustrates an example process 700 for performing filtering of V2X messages 120 using signal strength. In an example, the process 700 may be performed by the data filtering application 132 executed by the TCU 110 of the ego vehicle 102.

At operation 702, the ego vehicle 102 initializes filter statistical measures. This may include initializing to allow through all V2X messages 120 from all senders. In another example, this may include initializing to allow through all V2X messages 120 from all senders for which the ego vehicle 102 has not received any V2X messages 120 (or has not received V2X messages 120 in a predefined period of time).

At operation 704, the ego vehicle 102 collects V2X messages 120. In an example, the ego vehicle 102 may utilize the transceiver 112 to scan and accept multiple V2X messages 120. At operation 706, the ego vehicle 102 identifies the signal strength of the received V2X messages 120. The RSSI may be determined based on the RF energy received to the transceiver 112.

At operation 708, the ego vehicle 102 filters the V2X messages 120 according to the statistical measures. For example, if a V2X message 120 from a sender does not meet a statistical measure computed for that sender, V2X messages 120 from that sender may be filtered out and not processed. For instance, if the mean, median, or maximum RSSI for a sender does not meet a predefined mean, median, and or maximum RSSI threshold for the sender, then V2X messages 120 from that sender may be filtered out. Accordingly, responsive to the statistical measure not meeting a minimum threshold, then no further V2X messages 120 may be processed from that source (e.g., that road entity 124 or RSU 130) unless the RSSI measure crosses the threshold. If, however, the mean, median, or maximum RSSI for a sender exceeds the threshold then the V2X message 120 may be processed from that sender. Also, if insufficient information is received from the sender to compute the statistical measure for that sender, the V2X message 120 may also be allowed to be processed.

At operation 710, the ego vehicle 102 determined whether a collection period has elapsed. In an example, the ego vehicle 102 may collect V2X message 120 from each source within an interval (such as a second or less) for application processing. Responsive to the collection period being completed (e.g., every second), control passes to operation 712. Otherwise, control returns to operation 704 to continue collecting V2X messages 120.

At operation 712, the ego vehicle 102 updates the statistical measures. In an example, for each unique identified sender (e.g., road entity 124) in the collected V2X messages 120, the data filtering application 132 may derive a statistical measure of the RSSI of the received V2X messages 120. This statistical measure may include mean, median, or maximum RSSI, as some non-limiting examples. This statistical measure may then be used for the processing of V2X message 120 in future collection periods. In some examples, if insufficient V2X messages 120 are received from a sender that previously had a recorded statistical measure, then all messages from that V2X messages 120 may again be allowed. After operation 712, the process 700 returns to operation 702.

Additional criteria may be used for filtering V2X messages 120 as well. In an example, V2X message 120 may include information regarding one or more objects detected by sensors 106 of a road entity 124 or RSU 130. Filtering criteria may additionally be applied by the data filtering application 132 to the individual objects contained within with V2X message 120. For example, sensed objects outside the regions 202 may be discarded to reduce processing overhead.

Thus, the disclosed approaches to filtering of V2X messages 120 cooperatively combines V2X messages 120 from multiple broadcasters without information duplication and loss of critical information. Also, the disclosed approach reduces the computational load on the consumer of the V2X messages 120 applications on the ego vehicle 102.

Variations on the disclosed approaches are contemplated. In an example, the process 700 may be used to first filter the V2X messages 120 by signal strength, and then only the V2X messages 120 meeting that filtering may be processed by the process 600 according to the dynamic filter criteria 122.

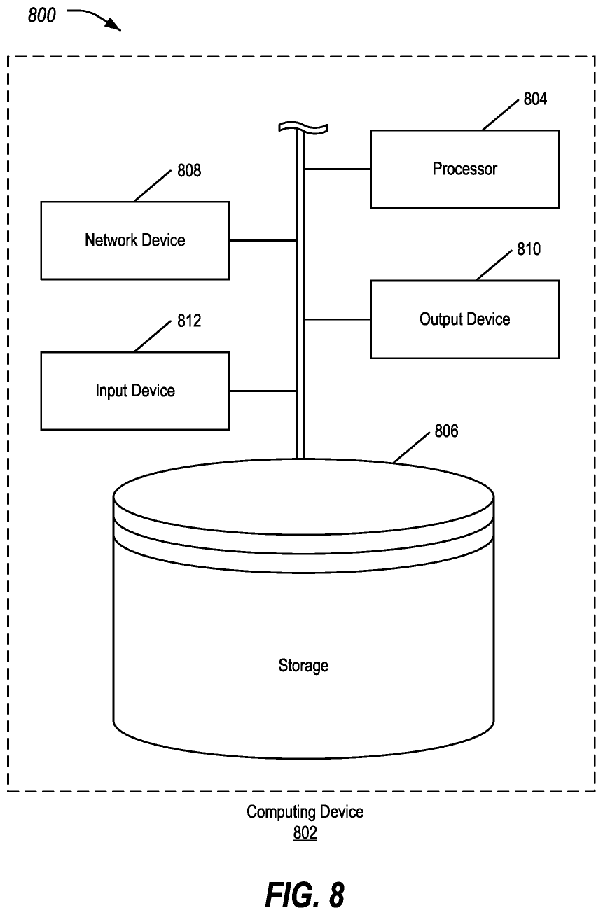

FIG. 8 illustrates an example 800 of a computing device 802 for use in performing filtering of V2X messages 120 using dynamic filter criteria 122. Referring to FIG. 8, and with reference to FIGS. 1-7, the ego vehicles 102, controllers 104, TCU 110, transceivers 112, processors 114, road entities 124, and RSUs 130 may be examples of such computing devices 802. As shown, the computing device 802 includes a processor 804 that is operatively connected to a storage 806, a network device 808, an output device 810, and an input device 812. It should be noted that this is merely an example, and computing devices 802 with more, fewer, or different components may be used.

The processor 804 may include one or more integrated circuits that implement the functionality of a central processing unit (CPU) and/or graphics processing unit (GPU). In some examples, the processors 804 are a system on a chip (SoC) that integrates the functionality of the CPU and GPU. The SoC may optionally include other components such as, for example, the storage 806 and the network device 808 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 804 executes stored program instructions that are retrieved from the storage 806, such as those of the data filtering application 132. The stored program instructions accordingly include software that controls the operation of the processors 804 to perform the operations described herein. The storage 806 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100. Examples of data stored to the storage 806 may include V2X messages 120, dynamic filter criteria 122, etc.

The GPU may include hardware and software for display of at least two-dimensional (2D) and optionally three-dimensional (3D) graphics to the output device 810. The output device 810 may include a graphical or visual display device, such as an electronic display screen, projector, printer, or any other suitable device that reproduces a graphical display. As another example, the output device 810 may include an audio device, such as a loudspeaker or headphone. As yet a further example, the output device 810 may include a tactile device, such as a mechanically raiseable device that may, in an example, be configured to display braille or another physical output that may be touched to provide information to a user.

The input device 812 may include any of various devices that enable the computing device 802 to receive control input from users. Examples of suitable input devices that receive human interface inputs may include keyboards, mice, trackballs, touchscreens, voice input devices, graphics tablets, and the like.

The network devices 808 may each include any of various devices that enable the vehicles 102 and road entities 124 to send and/or receive data from external devices over networks. Examples of suitable network devices 808 include an Ethernet interface, a Wi-Fi transceiver, a cellular transceiver, or a BLUETOOTH or Bluetooth Low Energy (BLE) transceiver, an ultra wideband (UWB) transceiver or other network adapter or peripheral interconnection device that receives data from another computer or external data storage device, which can be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An ego road entity for performing filtering of vehicle-to-everything (V2X) messages, comprising:
a transceiver; and
one or more controllers of the ego road entity, configured to
identify velocity of travel of the ego road entity,
adjust one or more distance thresholds of dynamic filter criteria according to the identified velocity,
receive, via the transceiver, a vehicle-to-everything (V2X) message,
identify, from the V2X message, a location of a remote road entity indicated by the V2X message,
filter the V2X message based on whether the location of the remote road entity is within the one or more distance thresholds,
process the V2X message only if the V2X message is not filtered out.

2. The ego road entity of claim 1, wherein to process the V2X message only if the V2X message is not filtered out reduces resource usage due to the filtered out V2X messages.

3. The ego road entity of claim 1, wherein the one or more controllers are further configured to:
identify a route of the ego road entity; and
compute the one or more distance thresholds based on distance of the ego road entity to the location of the remote road entity along the route.

4. The ego road entity of claim 1, wherein the one or more distance thresholds include a radius distance surrounding the ego road entity.

5. The ego road entity of claim 1, wherein the one or more distance thresholds include:
a first distance threshold defining a first region in front of the ego road entity in the direction of travel of the ego road entity;
a second distance threshold defining a second region behind the ego road entity in the direction of travel of the ego road entity;
a third distance threshold defining a third region in front of the ego road entity in an opposite direction from the direction of travel of the ego road entity; and
a fourth distance threshold defining a fourth region behind the ego road entity in the opposite direction from the direction of travel of the ego road entity.

6. The ego road entity of claim 5, wherein to adjust the one or more distance thresholds includes increasing each of the first, second, third, and fourth distance thresholds as the velocity of the ego road entity increases.

7. The ego road entity of claim 5, wherein to adjust the one or more distance thresholds includes increasing the first and third distance thresholds as the velocity of the ego road entity increases.

8. The ego road entity of claim 7, wherein to adjust the one or more distance thresholds includes decreasing the second and fourth distance thresholds as the velocity of the ego road entity increases.

9. The ego road entity of claim 1, wherein the amount of increase in the one or more distance thresholds is proportional to distance traveled by the ego road entity per unit time.

10. The ego road entity of claim 1, wherein the one or more controllers are further configured to:
receive V2X messages from the remote road entity over a predefined period of time;
derive a statistical measure of received signal strength indicator (RSSI) of the V2X messages over the period of time; and
filter out the V2X messages responsive to the statistical measure not meeting a threshold value over the period of time.

11. The ego road entity of claim 10, wherein the statistical measure is mean, median, or maximum RSSI over the period of time.

12. The ego road entity of claim 1, wherein the ego road entity is an ego vehicle.

13. The ego road entity of claim 1, wherein the ego road entity is a roadside unit (RSU).

14. A method for performing filtering of V2X messages by an ego road entity, comprising:
identifying velocity of travel of the ego road entity;
adjusting one or more distance thresholds of dynamic filter criteria according to the identified velocity;
receiving, via a transceiver of the ego road entity, a vehicle-to-everything (V2X) message;
identifying, from the V2X message, a location of a remote road entity indicated by the V2X message;
filtering the V2X message based on whether the location of the remote road entity is within the one or more distance thresholds; and
processing the V2X message only if the V2X message is not filtered out.

15. The method of claim 14, wherein performing application-layer processing of the V2X message only if the V2X message is not filtered out reduces resource usage by the ego road entity.

16. The method of claim 14, further comprising:
identifying a route of the ego road entity; and
computing the one or more distance thresholds based on distance of the ego road entity to the location of the remote road entity along the route.

17. The method of claim 14, wherein the one or more distance thresholds include a radius distance surrounding the ego road entity.

18. The method of claim 14, wherein the one or more distance thresholds include:
a first distance threshold defining a first region in front of the ego road entity in the direction of travel of the ego road entity;
a second distance threshold defining a second region behind the ego road entity in the direction of travel of the ego road entity;
a third distance threshold defining a third region in front of the ego road entity in an opposite direction from the direction of travel of the ego road entity; and
a fourth distance threshold defining a fourth region behind the ego road entity in the opposite direction from the direction of travel of the ego road entity.

19. The method of claim 18, wherein to adjust the one or more distance thresholds includes increasing each of the first, second, third, and fourth distance thresholds as the velocity of the ego road entity increases.

20. The method of claim 18, wherein to adjust the one or more distance thresholds includes increasing the first and third distance thresholds as the velocity of the ego road entity increases.

21. The method of claim 20, wherein to adjust the one or more distance thresholds includes decreasing the second and fourth distance thresholds as the velocity of the ego road entity increases.

22. The method of claim 14, wherein the amount of increase in the one or more distance thresholds is proportional to distance traveled by the ego road entity per unit time.

23. The method of claim 14, further comprising:
receiving V2X messages from the remote road entity over a predefined period of time;
deriving a statistical measure of received signal strength indicator (RSSI) of the V2X messages over the period of time; and
filtering out the V2X messages responsive to the statistical measure not meeting a threshold value over the period of time, wherein the statistical measure is mean, median, or maximum RSSI over the period of time.

24. A non-transitory computer readable medium comprising instructions for filtering of V2X messages by an ego vehicle that, when executed by one or more controllers, cause the one or more controllers to perform operations including to:
identify velocity of travel of the ego vehicle;
adjust one or more distance thresholds of dynamic filter criteria according to the identified velocity;
receive, via a transceiver of the ego vehicle, a vehicle-to-everything (V2X) message;
identify, from the V2X message, a location of a remote road entity indicated by the V2X message;
derive a statistical measure of received signal strength indicator (RSSI) of other V2X messages from the remote road entity over a period of time;
filter out the V2X message responsive to the statistical measure not meeting a threshold value over the period of time, wherein the statistical measure is mean, median, or maximum RSSI over the period of time;
filter the V2X message based on whether the location of the remote road entity is within the one or more distance thresholds; and
process the V2X message only if the V2X message is not filtered out.

25. The non-transitory computer readable medium of claim 24, wherein performing application-layer processing of the V2X message only if the V2X message is not filtered out reduces resource usage by the ego road entity.
